(19) United States
(12) Patent Application Publication
(10) Pub. No.: US 2011/0313942 A1
(43) Pub. Date: Dec. 22, 2011

(54) SYSTEM AND METHOD FOR PROVIDING DEPARTMENTS WITH CANDIDATE TEST SCORES AND PROFILES

(75) Inventor: Michael S. Higgins, Grosse Point Farms, MI (US)

(73) Assignee: Empco, Inc., Troy, MI (US)

(21) Appl. No.: 13/166,109

(22) Filed: Jun. 22, 2011

Related U.S. Application Data
(60) Provisional application No. 61/357,307, filed on Jun. 22, 2010.

(51) Int. Cl. G06Q 10/00

(52) U.S. Cl. 705/321

(57) ABSTRACT

Multiple departments of an organization can cooperate to simplify the testing process and enlarge the pool of qualified candidates for each department. Each department advertises for candidates, but requests that they also register at a website to apply to take a test rather than send any paperwork directly to the department. On the web site, candidates provide personal profile information, schedule a test at a test site in their area, and select their department preference. When the department is ready to interview candidates, a user logs in to the web site and downloads a tailored list of qualified candidates that have 1) met that department's predetermined hiring criteria, and 2) indicated they are willing to work at that department. The interviewer then contacts the candidates and proceeds with their normal application procedures.

### BACKGROUND OF THE INVENTION

Many online employment services help connect job candidates and employers. A vast majority of these services merely collect resumes and redistribute them to the employers, providing nothing more than a virtual meeting place.

### SUMMARY OF THE INVENTION

The present invention provides a system and method for testing and presenting a candidate's personal profile. Multiple departments can cooperate to simplify the testing process and enlarge the pool of qualified candidates for each department. Each department advertises as usual for candidates, but requests that they also register at a website to apply to take a test rather than send any paperwork directly to the department. On the web site, candidates provide personal profile information, schedule a test at a test site in their area, and choose the departments where they are willing to work. When the department is ready to interview candidates, an interviewer logs in to the web site and views test scores and personal profiles of the candidates that have 1) met that department's predetermined hiring criteria, and 2) indicated they are willing to work at the interviewer's department. The interviewer then contacts the candidates and proceeds with their normal application procedures.

The present invention eliminates a large amount of work for each department because they are no longer involved in the initial paper-shuffling process of attempting to determine whether a candidate meets their minimum qualifications. In addition, because each departments' advertising includes the web site, the pool of candidates for each department is potentially greater.

These and other features of the invention will be more fully understood and appreciated by reference to the description of the embodiments and the drawings.

### BRIEF DESCRIPTION OF THE DRAWINGS

FIG. 1 is a system diagram illustrating one embodiment of a system for testing and placing candidates.

FIG. 2 is a block diagram illustrating the various modules included in one embodiment of a server.

FIG. 3 is a block diagram of the various interfaces included in one embodiment of an administration module.

FIG. 4 is a block diagram of the various interfaces included in one embodiment of a department module.

FIG. 5 is a block diagram of the various interfaces included in one embodiment of a test site module.

FIG. 6 is a block diagram of the various interfaces included in one embodiment of a candidate module.

FIG. 7 illustrates one embodiment of a login interface.

FIG. 8 illustrates one embodiment of a current tests interface.

FIG. 9A illustrates one embodiment of a manage test sites interface.

FIG. 9B illustrates one embodiment of a manage departments interface.

FIG. 10 illustrates one embodiment of a manage candidates interface.

FIG. 11 illustrates one embodiment of a quick search interface.

FIG. 12 illustrates one embodiment of an advanced search interface.

FIG. 13 illustrates one embodiment of a manage department information interface

FIG. 14 illustrates one embodiment of a manage department hiring criteria interface.

FIG. 15 illustrates one embodiment of the scheduled tests interface and the add a new test interface.

FIG. 16 illustrates one embodiment of a manage test site information interface.

FIG. 17 illustrates one embodiment of a candidate home interface.

FIGS. 18A-18B illustrate one embodiment of a personal information interface.

FIG. 19 illustrates one embodiment of a departments interface.

FIG. 20 illustrates one embodiment of a schedule test interface.

FIG. 21 illustrates one embodiment of an update status interface.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DESCRIPTION OF CURRENT EMBODIMENTS

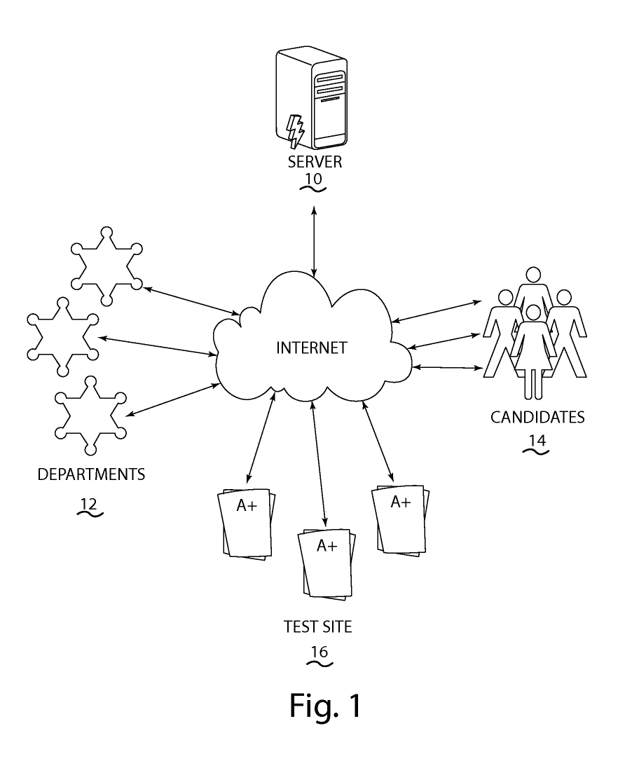

FIG. 1 is a system diagram illustrating one embodiment of a system for testing and contacting candidates. In the current embodiment, the system includes a server 10, multiple departments 12, multiple candidates 14, and multiple test sites 16. Each candidate 14 can access the web site located on the server 10 and create a profile with a login and password. Upon logging in to the web site, each candidate can enter a brief personal profile and select the department or departments that will have access to their profile and test scores. Using the web site, each candidate can reserve a seat for a test at a test site. The test site reports the test results to the server 10 where they are processed and provided to the appropriate departments 12 depending on the candidate's department selection and each department's minimum hiring criteria.

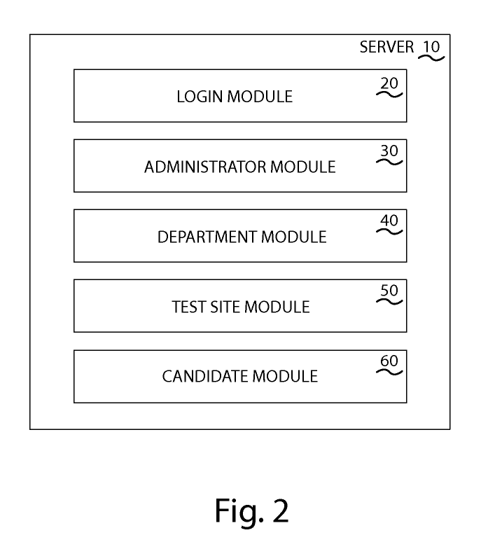

FIG. 2 is a block diagram illustrating the various modules included in one embodiment of a server 10. The server 10 in the current embodiment is a web server accessible on the Internet. In alternative embodiments, the server 10 may be accessible on a different network and may be a different type of server. In the current embodiment, the server 10 includes a login module 20, an administrator module 30, a department module 40, a test site module 50, and a candidate module 60. Each of these modules represents a portion of the web site being served by the web server in the current embodiment. In alternative embodiments, the server 10 may include additional or fewer modules. The term module should be understood to mean any and all software associated with providing that module's function. For example, each module may include the code for processing information, displaying information to the user, or accepting input from a user. The modules may include code written in HTML, Flash, Java, or any other computer programming language in order to provide the functionality for that particular module. The code for each module may not be exclusive to that module and may be reused in multiple modules.

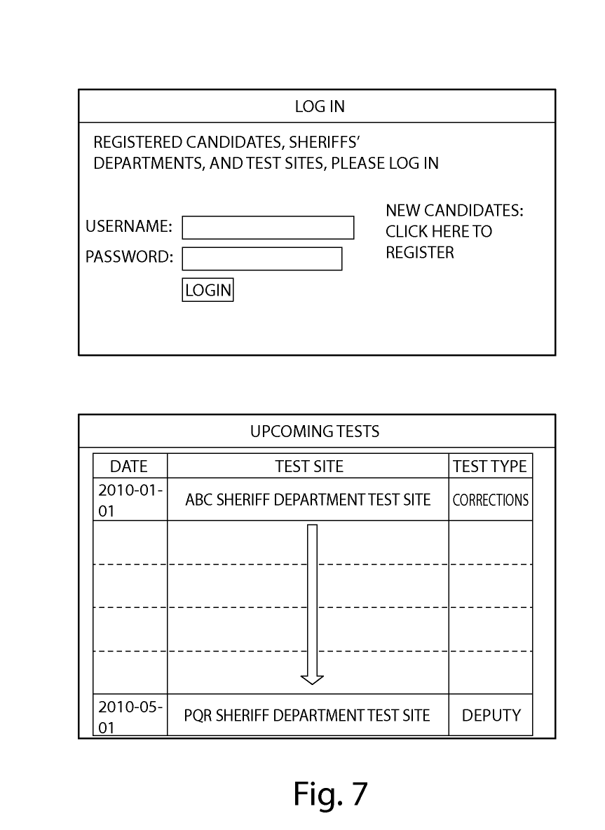

The login module 20 includes the code supporting the login interface for the web site that allows a system administrator, a department interviewer, a test site administrator, or a candidate to access the appropriate section of the web site for that individual. In the current embodiment, the login module 20 provides a single login interface (see FIG. 7) where depending on the user name and password entered into the interface a different interface can be accessed. In alternative embodiments, the login module may provide different interfaces for logging in to the appropriate section of the web site for the system administrator, department interviewer, test site administrator, or candidate. The login interface may display additional information, for example the upcoming test dates and locations, as shown in the exemplary login interface shown in FIG. 7. The login interface may also include other information about the departments as a group, frequently asked questions, and standards for hiring.

The login interface includes login and password fields that can be used to log in to the candidate interface, test site interface, administrator interface, or department interface. In alternative embodiments, separate login interfaces may be created to reach some or all of the other interfaces. New candidates may also have the option of creating a new login. Test sites and departments may be assigned passwords and IDs by the administrator. In alternative embodiments, a request and approval system may be included in the login interface so they can apply for a login without being assigned one.

The administration module provides the interfaces that can allow a system administrator to 1) add/delete test sites or modify test site information; 2) add/delete departments or modify department information; and 3) correct errors in candidate information. Adding or deleting a test site, department, or candidate may include adding or deleting a login and password for the web site.

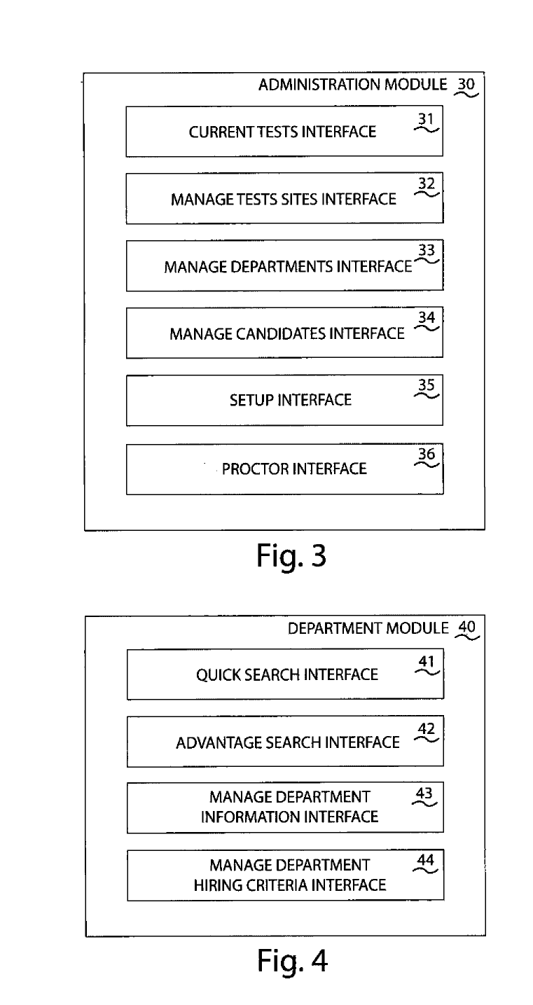

FIG. 3 is a block diagram illustrating the various interfaces included in one embodiment of an administration module 30. In the current embodiment, the administration module 30 includes a current tests interface 31, a manage test sites interface 32, a manage departments interface 33, manage candidates interface 34, a testing provider setup interface 35, and a testing provider proctor interface 36.

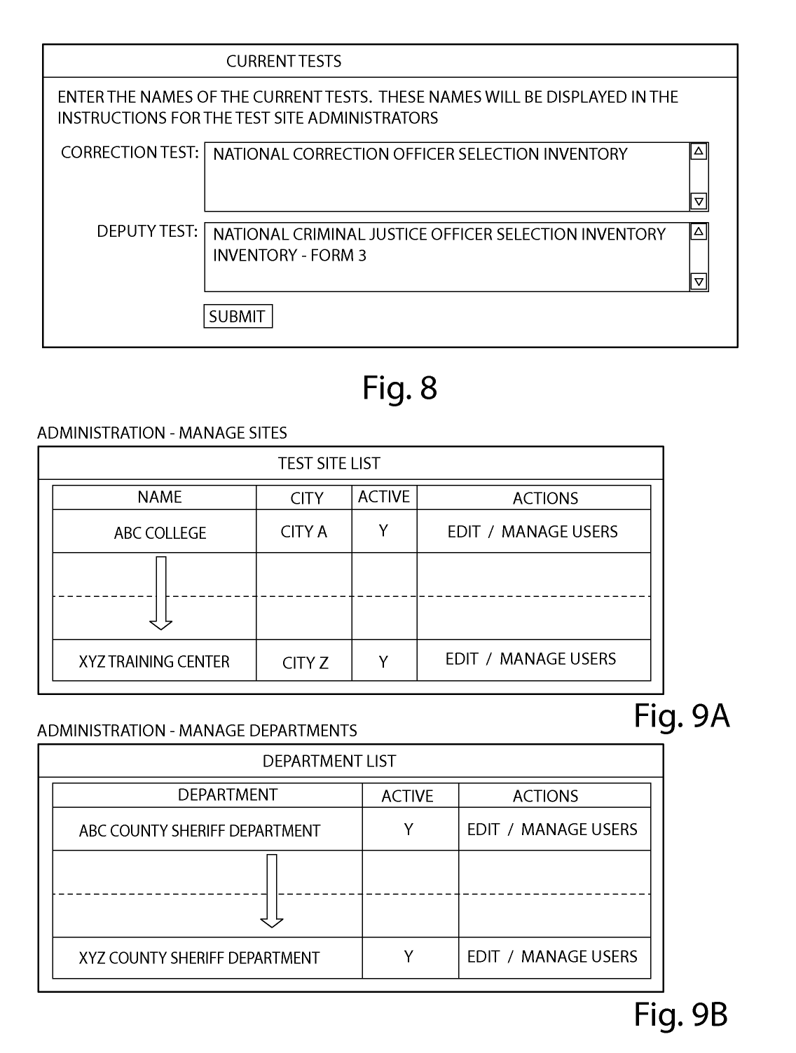

FIG. 8 illustrates one embodiment of a current tests interface 31. The current tests interface 31 allows the administrator to change the names of the tests that will be displayed in the instructions for the test site administrators.

FIG. 9A illustrates one embodiment of a manage test sites interface 32. In the illustrated embodiment, the manage test sites interface 32 provides a list of test sites, each having a name, location, active indication, and list of available actions. In the current embodiment, test sites can be added or deleted, and users associated with each test site can be added or deleted.

FIG. 9B illustrates one embodiment of a manage departments interface 33. In the illustrated embodiment, the manage departments interface 33 provides a list of sheriff departments, each having a department name, active indication, and list of available actions. In the current embodiment, departments can be added or deleted, and users associated with each department can be added or deleted.

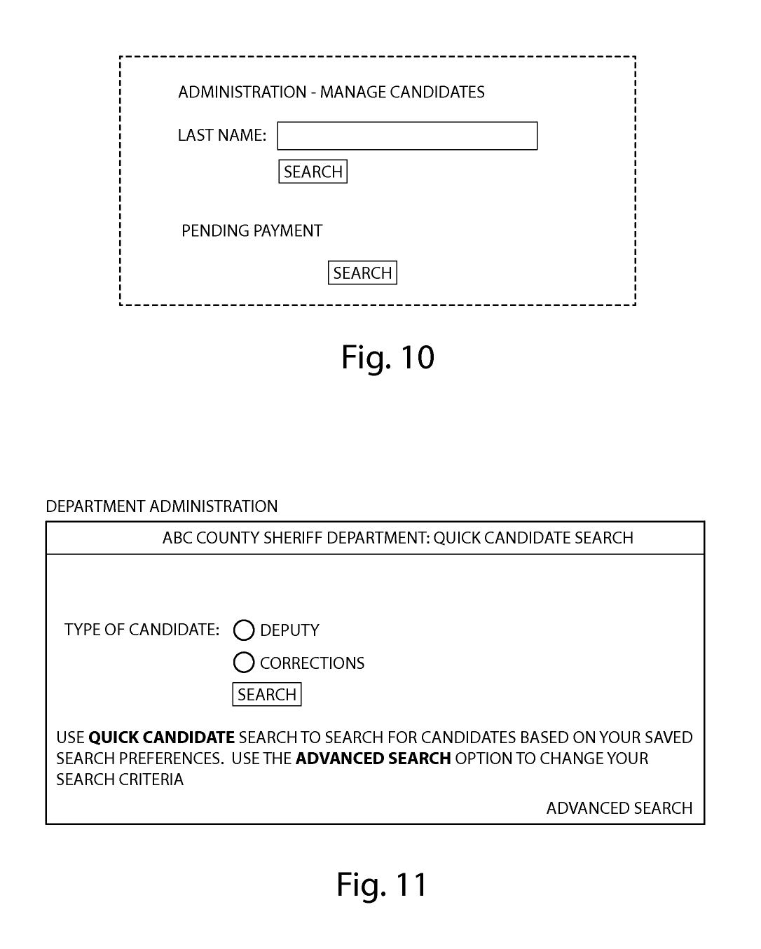

FIG. 10 illustrates one embodiment of a manage candidates interface 34. In the illustrated embodiment, the manage candidates interface 34 provides a search box where a candidate's last name can be entered. Once a candidate is located using the search, any of the candidate's information can be verified or changed. For example, a candidate's payment status can be verified or changed.

Information for the administrator module, including the various login and password information may be stored in a local database on the server 10 or a remote database located elsewhere on the network. In the current embodiment, the setup interface 35 and proctor interface 36 each include a link to a third-party site responsible for administering a test. The setup interface includes a password/username page for test sites to login to the test site. In some embodiments, this link may be used for a test proctor to login to give a test. The proctor is an optional interface for test takers to log in to the third-party test taking site.

The administrator module can also provide an interface to generate reports. For example, an accounting report or registration report may be generated by the administration module.

The department module provides the interfaces that can allow an interviewer to 1) search for candidates that meet the selection criteria; 2) manage the department information; and 3) manage the department selection criteria.

FIG. 4 is a block diagram illustrating the various interfaces included in one embodiment of a department module 40. In the current embodiment, the department module 40 includes a quick search interface 41, an advanced search interface 42, a manage department information interface 43, and a manage department hiring criteria interface 44.

Various levels of searching can be provided. The quick search interface provides a way for an interviewer to quickly see all candidates for a particular position that both meet the department minimum selection criteria and have a desire to work at the interviewer's department. The advanced search interface may provide some additional searching options, such as limiting the search results to candidates in one or more particular locations, limiting the search results based on when the candidate sat for the test, or limiting the search results based on candidate scores. The advanced search tool may also allow searching by candidate name. The search results can display various information about the candidate. In the current embodiment, the search results display the score, name, residence, test date, test site, and actions for each candidate. The search results display options can be altered in the advanced search interface. For example, the search results can be sorted by any of the various fields. The search results can be downloaded into a spreadsheet format including complete candidate profile information. This information can be used to mail merge, email, or call any candidates to begin the department's normal selection process.

FIG. 11 illustrates one embodiment of a quick search interface 41. In the illustrated embodiment, the quick search interface 41 provides the ability to select the type of candidate that the sheriff department administrator is searching for, in this case, a deputy or a corrections candidate. By then selecting search, the candidate search will be performed based on the saved search preferences for that department.

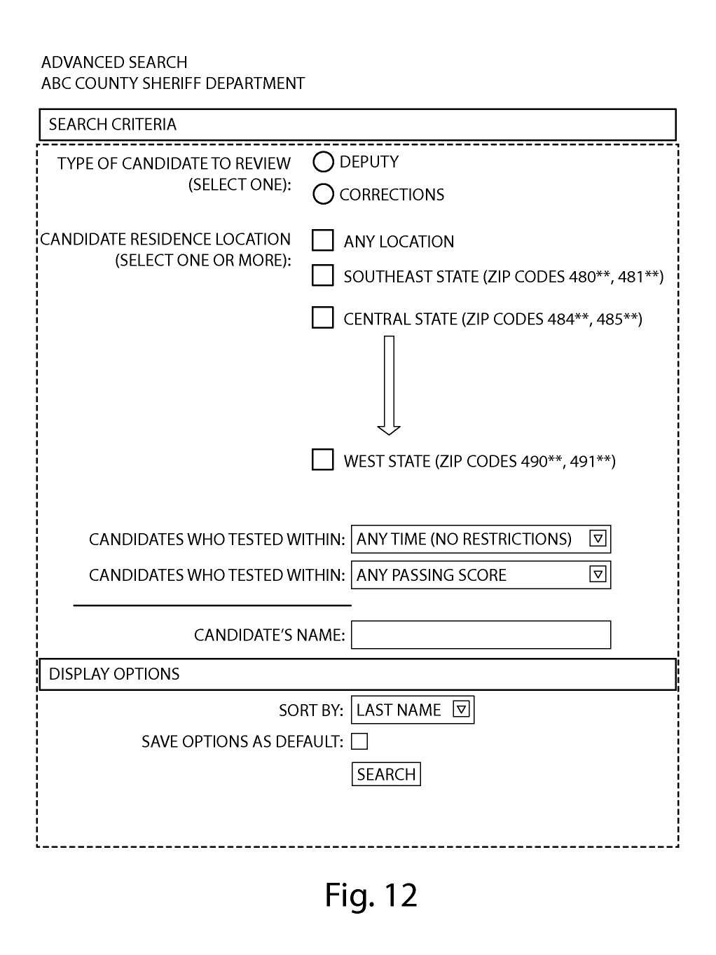

FIG. 12 illustrates one embodiment of an advanced search interface 42. In the illustrated embodiment, the advanced search interface 42 provides additional restrictions for the candidate search. For example, in addition to selecting the type of candidate, the user can select one or more candidate residence locations to restrict the search if a candidate residing in a particular location is desired. In addition, the search can be tailored based on candidates who tested within a particular timeframe or received a particular score or range of score. Further, a particular candidate may be searched by name.

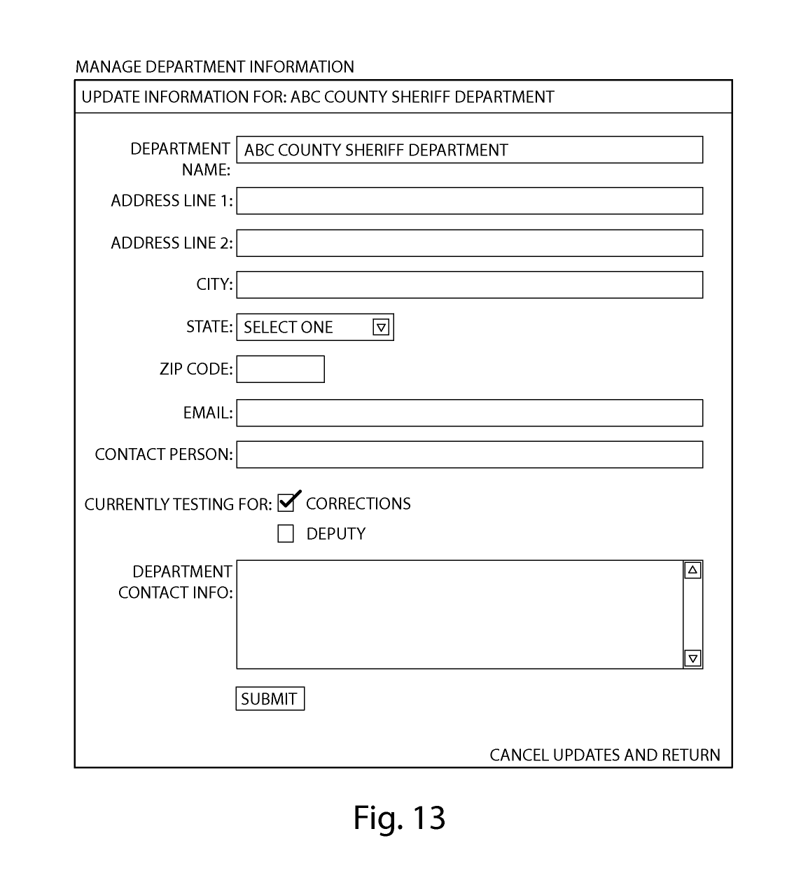

The manage department information interface 43 can allow the department information to be updated. The department information interface can allow the department name, address, and contact information to be changed. The currently testing field indicates what position(s) the department is testing for. FIG. 13 illustrates one embodiment of a manage department information interface 43. In the illustrated embodiment, the manage department interface 43 provides the ability for a user to update or change information about the sheriff department. For example, the name, address, email, contact person, and the type of candidates that the department is currently testing for, can be updated through this interface.

The manage department hiring criteria interface 44 allows the department to set its minimum selection criteria. Only candidates that meet the department's requirements will be displayed when performing a search. In the current embodiment, candidates may also be required to meet some additional baseline criteria to be considered for any department. Examples of minimum selection criteria that can be altered in the current embodiment include: minimum age, minimum education level, having a driver's license, prior experience at that position, and police academy training. These minimum selection criteria represent the department's written, legal minimum standards, below which, a candidate cannot be selected.

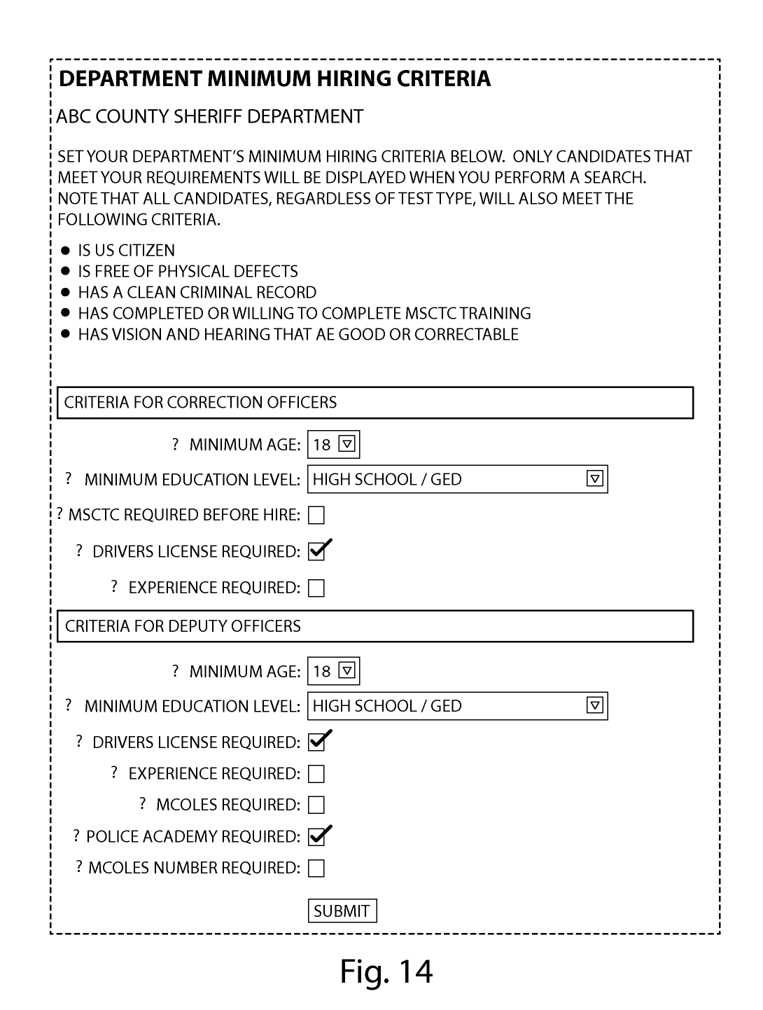

FIG. 14 illustrates one embodiment of a manage department hiring criteria interface 44. In the illustrated embodiment, the manage department hiring criteria interface 44 provides selectable hiring criteria for corrections officers and selectable hiring criteria for deputy officers. In alternative embodiments criteria for additional or different positions can be included in the department hiring criteria. In addition to the dynamically selectable hiring criteria, which can be varied by each sheriff department, there may be static non-selectable hiring criteria that cannot be varied by any one sheriff department. That is, the static hiring criteria may form a base threshold of minimum hiring criteria of which no candidate below can be hired. Additional minimum hiring criteria above and beyond the base threshold may be dynamically selected by each sheriff department.

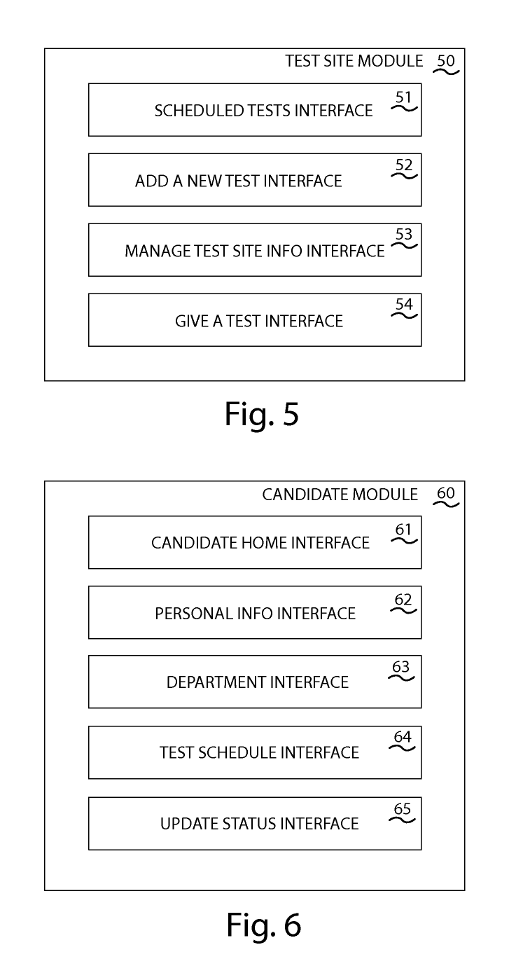

FIG. 5 is a block diagram illustrating the various interfaces included in one embodiment of a test site module 50. In the current embodiment, the test site module 50 includes a scheduled tests interface 51, an add a new test interface 52, a manage test site info interface 53, a give a test interface 54. In the current embodiment, the test site module 50 can allow a test site to 1) manage the test site information; 2) view scheduled tests; 3) schedule a new test at that test site; and 4) proctor a test.

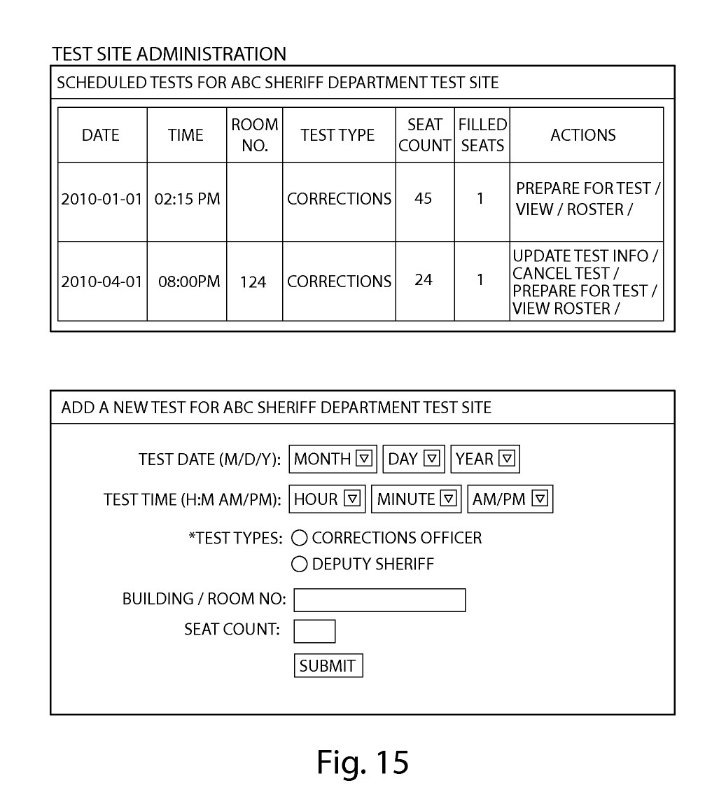

Referring to FIG. 15, an embodiment of the scheduled tests interface 51 and the add a new test interface 52 are illustrated. The scheduled tests interface 51 of the illustrated embodiment provides a list of the various dates, times, and locations for any scheduled tests. In addition, the number of seats taken and available may also be displayed. The scheduled test interface may provide some additional functionality for managing the tests. For example, the test site module can provide the ability to prepare for a test, view the roster of test takers, update the test information, or cancel the test. The add a new test interface 52 of the illustrated embodiment provides an interface for adding a new test. In the current embodiment, the test date, test time, test type, building number, and seat count can be selected to add the test to a test site database. Once added, the scheduled test will be available in the scheduled tests interface to be managed.

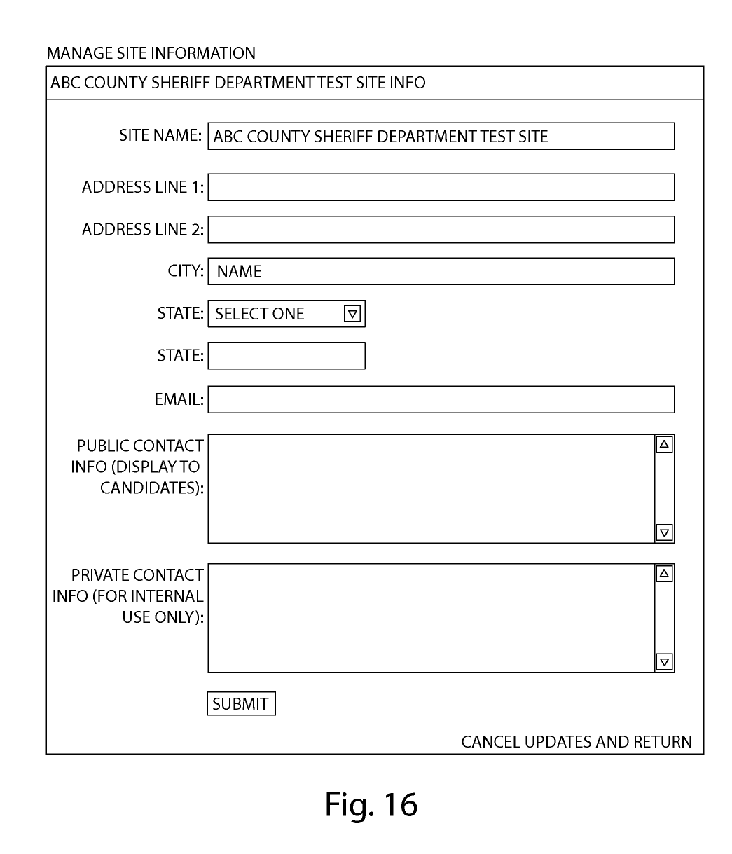

Referring to FIG. 16, an embodiment of the manage test site information interface is illustrated. In the illustrated embodiment, the manage test site information interfaces provides a user with the ability to update the information about a test site, such as the test site name, address, email, public contact information, and private contact information.

The test site module may include additional functionality. One embodiment of the test site module can automatically cancel a test with attendance below a threshold at a particular date/time. For example, if a test site is created with 50 seats available and two candidates sign up to take the test. A few days before the test is scheduled, the test may be automatically cancelled due to lack of attendance. Candidates will automatically be notified of the cancellation and be given a credit allowing them to reschedule for another test date. The test site module can send test site contact and map information to any candidate that schedules a test for that test site location.

The test site proctor can give a test using the give a test interface 54. This interface allows the proctor to generate a sign-in sheet that provides a way to verify that all of the candidates that signed up are present. The candidates can then log in to individual computers using their social security number in order to take the test. When the candidate completes the test, the computer automatically grades the test and updates the server 10 with a spreadsheet of candidate social security numbers with the associated test score. In this way, the proctor can verify that all of the candidates are present without necessarily being able to match each candidate to their test score. The social security numbers and associated test scores can be transmitted to the server 10 for processing.

FIG. 6 is a block diagram illustrating the various interfaces included in one embodiment of a candidate module 60. In the current embodiment, the candidate module 60 includes a candidate home interface 61, a personal information interface 62, a departments interface 64, a test schedule interface, an update status interface. In the current embodiment, the candidate module 60 allows a candidate to 1) view various information about the candidate's status; 2) enter or update candidate information; 3) select departments that will see the candidate's test scores; 4) reserve a seat for a test; or 5) change status from active to inactive or vice versa.

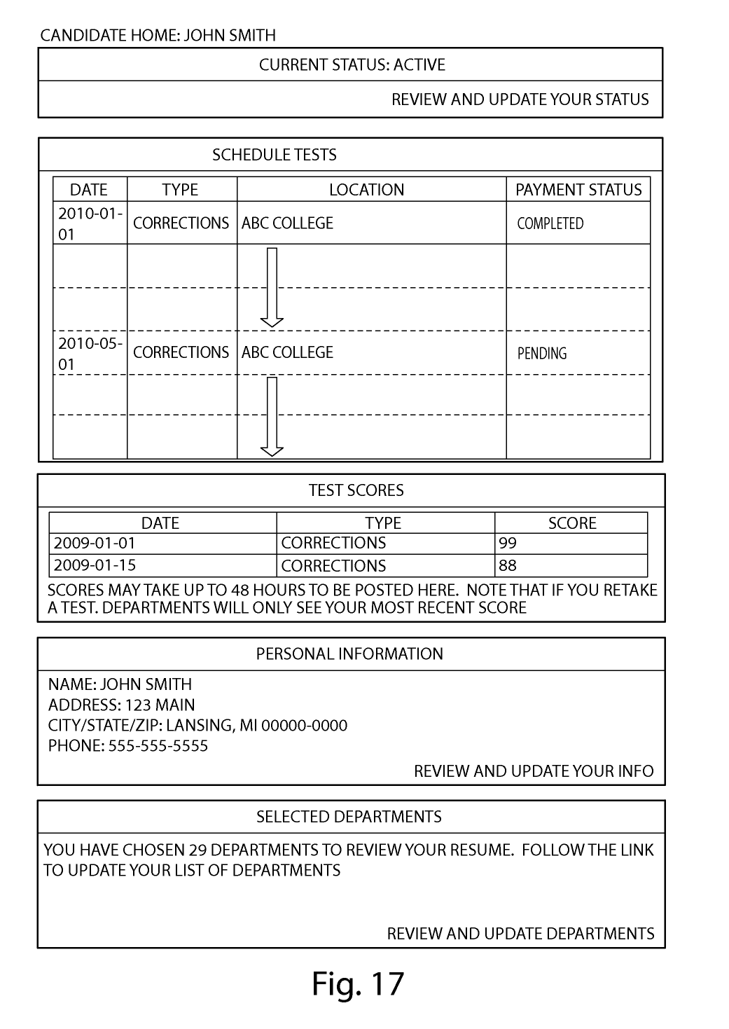

Referring to FIG. 17, the candidate home interface 61 in the current embodiment displays the candidate's current status active or inactive. The candidate home interface also displays the tests that the candidate is scheduled to take and some information about each test, including the date of the test, the type of test, the location of the test, and the payment status of the test. Additional or less information may be provided in alternative embodiments. The candidate home interface 61 can also display the candidate's test scores. The candidate home interface may also display information about the candidate, such as name, address, and phone number. The candidate home interface can also display the number of departments selected to review the candidate's resume.

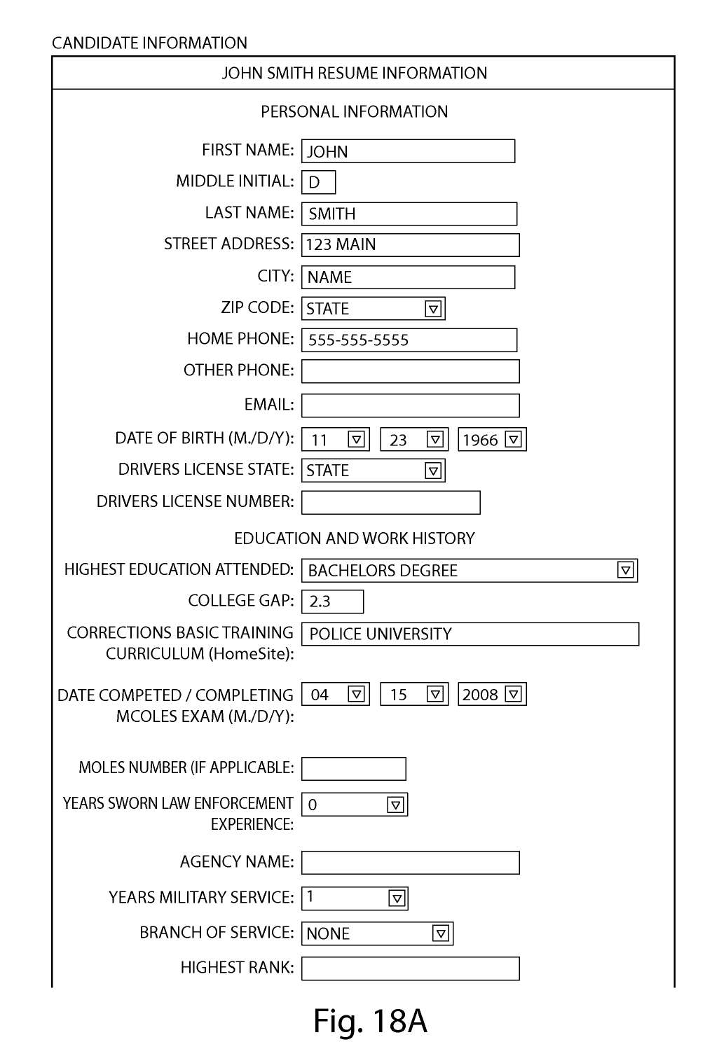

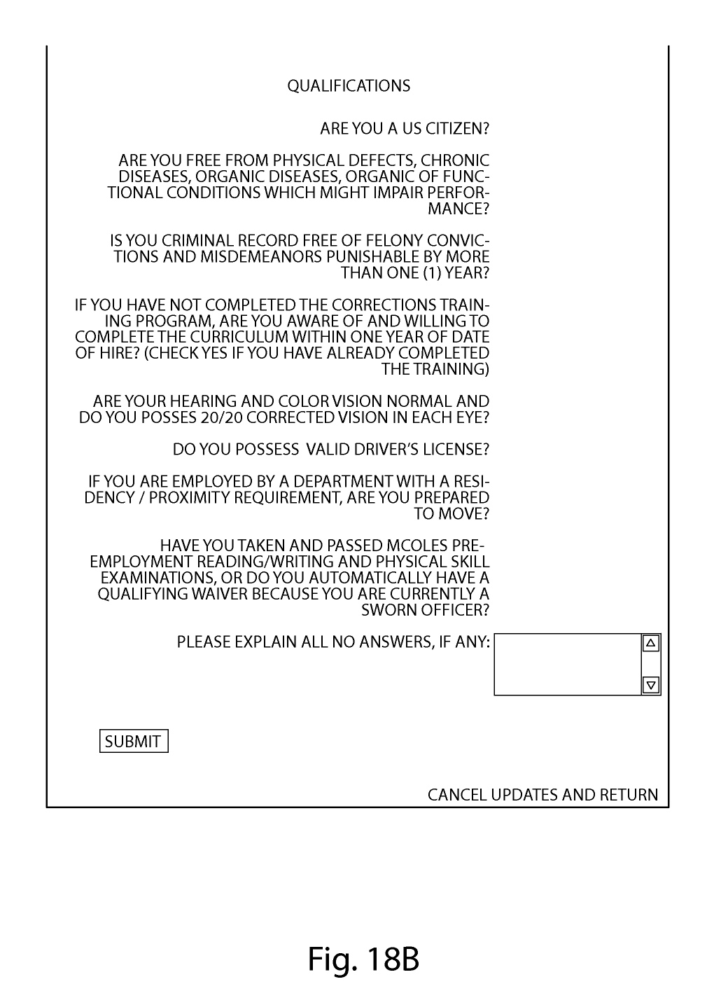

Referring to FIGS. 18A-18B, the personal information interface 62 provides a number of questions where the candidate can enter the answers into the provided fields. The information can then be stored in a database on the server 10. Some of the information that a candidate can be asked to provide includes personal information. Exemplary questions that can be asked of the candidate includes questions about the candidates name, residence, phone number, email, date of birth, driver's license, education and work history, and qualifications.

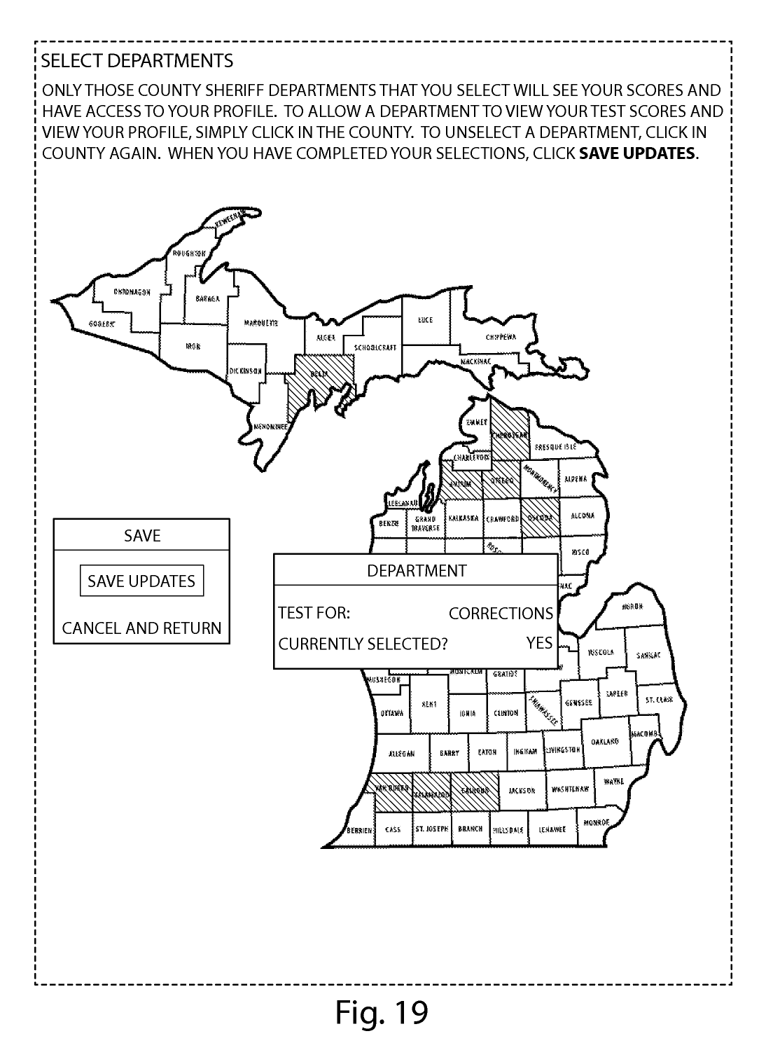

Referring to FIG. 19, the departments interface 63 allows the candidate to select the departments that will see the candidate's test scores and have access to the candidate's profile. In one exemplary embodiment, a map of various counties where each county has a department can be displayed and the candidate can select or deselect various counties.

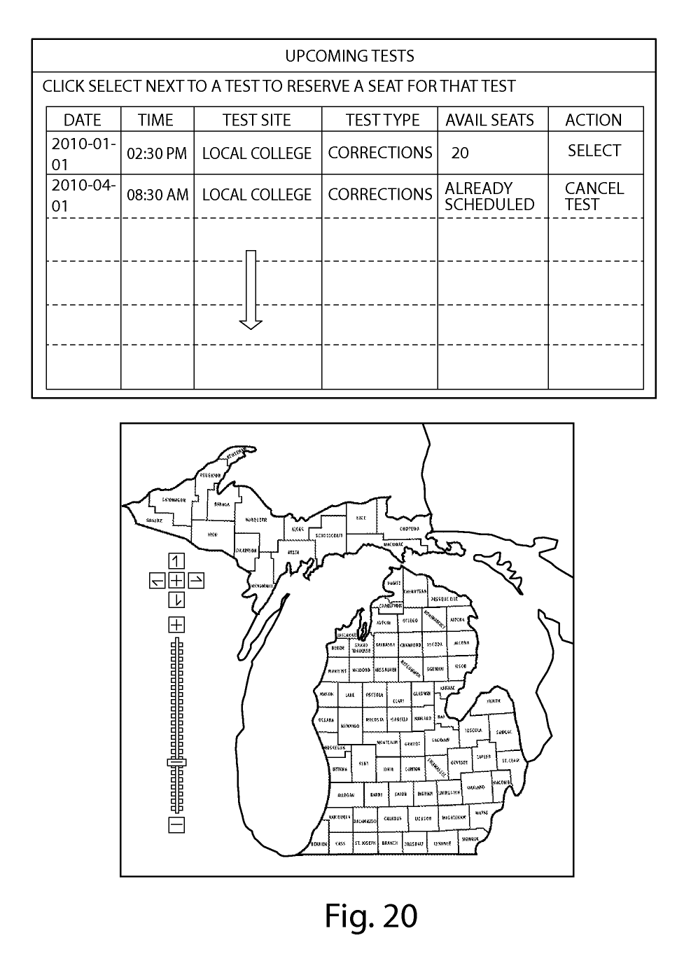

Referring to FIG. 20, the schedule test interface 64 allows a candidate to reserve a seat for a test or to cancel a reservation for a test that the candidate previously reserved. The schedule test interface 64 provides a list of available upcoming tests with openings. The schedule test interface 64 can provide a myriad of information about the tests, including, for example: date, time, test site location, test type, and available number of seats. Upon scheduling a test, the candidate can be prompted for payment, for example using Paypal or the candidate can indicate that he will mail a check. In alternative embodiments, additional or different payment options can be provided. In the current embodiment, payments all go to the administrator, in alternative embodiments, payments may be handled differently. In the current embodiment, if the candidate indicates that he will pay by check and the check is not received by the administrator by a particular date before the scheduled test, then the candidate will be automatically dropped from that test.

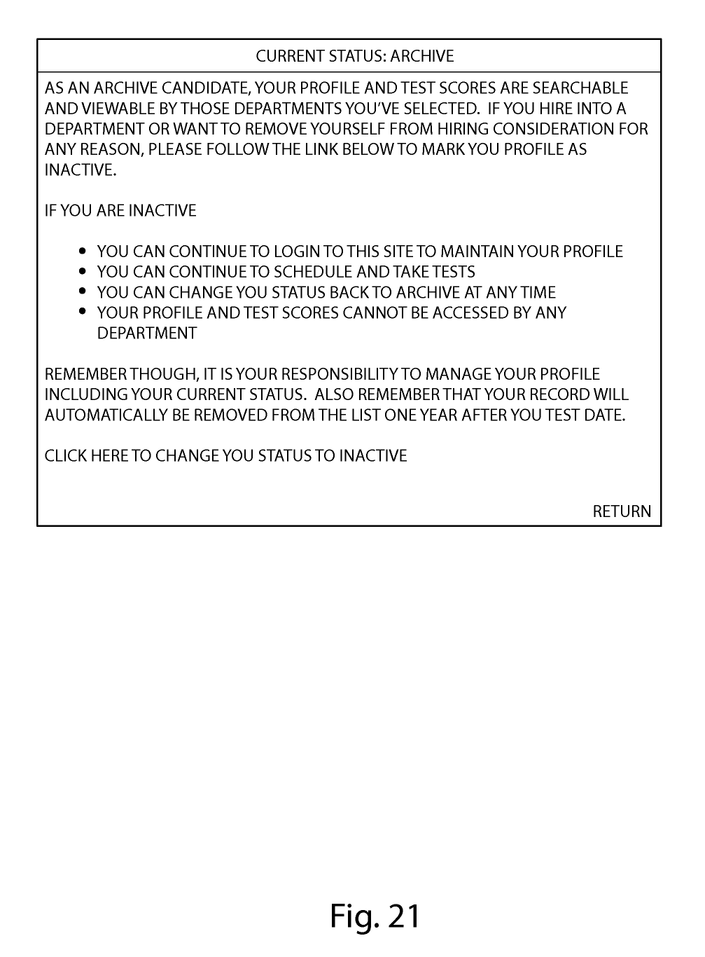

Referring to FIG. 21, the update status interface 65 can provide information to the candidate about the definition of active and inactive in the system. In the current embodiment, an active candidate's profile and test scores are searchable and viewable by the departments selected by the candidate. If a candidate wants to remove themselves from hiring consideration for any reason, the candidate can change his status to inactive. Inactive candidates may maintain some privileges, such as the ability to login and maintain the candidate profile, schedule and take tests, or change status back to active. While inactive, the candidate's profile and test scores cannot be accessed by any department. In alternative embodiments, the candidate status feature may be eliminated or provide a different set of features to the candidate depending on the candidate's status.

One embodiment of a method for testing candidates at various positions includes establishing in a database a plurality of departments, a plurality of test sites, and a plurality of candidates. The method further includes obtaining candidate information from each of the candidates, obtaining a test site location from each of the candidates, obtaining a department preference from each candidate, communicating each candidate's test results from the test site to each department in that candidate's department preference, and providing a list of qualified candidates to each department based on that department's minimum selection criteria.

The above description is that of current embodiments of the invention. It is to be understood that the invention disclosed and defined herein extends to all alternative combinations of two or more of the individual features mentioned or evident from the text and/or drawings. All of these different combinations constitute various alternative aspects of the present invention.

1. A system for testing a plurality of candidates at a plurality of test sites and generating a qualified list of candidates for each of a plurality of departments, the system comprising:
a database including a list of the plurality of departments of the organization, a list of the plurality of test sites, and a list of the plurality of candidates;
a test site module for scheduling tests at the plurality of test sites and receiving the test results;
a candidate module for receiving candidate information and for receiving a candidate department preference for each of the plurality of candidates;
a department module for establishing department minimum hiring criteria for each of the plurality of departments; and
wherein the department module generates a qualified list of candidates for each of the plurality of departments based on department minimum hiring criteria, the candidate department preference, and the test results.

2. The system of claim 1 including an administration module for adding or deleting test sites from the list of the plurality of test sites or for adding or deleting departments from the list of the plurality of departments.

3. The system of claim 2 wherein the administration module includes a current tests interface for displaying and managing the currently scheduled tests, a manage test sites interface for displaying and managing the list of the plurality of test sites, a manage departments interface for displaying and managing the list of the plurality of departments, a manage candidates interface, an setup interface, and an proctor interface.

4. The system of claim 1 wherein the department module includes a search interface for searching for and displaying candidates that both meet department minimum criteria and the candidate department preference, a manage department information interface for managing department information, and a manage department hiring criteria interface for managing department minimum criteria.

5. The system of claim 1 wherein the test site module includes a scheduled tests interface for displaying the times, dates, and locations for any scheduled tests, an add a new test interface for adding a new test, a manage test site info interface for managing test site information, and a give a test interface for giving a test.

6. The system of claim 1 wherein the candidate module includes a candidate home interface for displaying candidate status, scheduled tests, and test scores, a personal information interface for receiving personal candidate information, the departments interface for selecting one or more of the plurality of departments to have access to the candidate test scores, and a schedule test interface for making a test reservation.

7. A method for providing a plurality of departments of an organization with a tailored list of candidates for each of the plurality of departments, the method comprising:
through the use of a software interface, receiving a candidate department preference and a test result for each of a plurality of candidates;
through the use of a software interface, receiving department minimum hiring criteria for each of the plurality of departments;
determining whether each of the plurality of candidates meets each departments minimum hiring criteria based at least in part on the test result for each of the plurality of candidates;
generating a tailored list of candidates for each of the plurality of departments based on whether the candidate meets the minimum hiring criteria and the candidate department preference.

8. The method of claim 7 including managing a list of test sites and managing a list of the plurality of departments of the organization.

9. The method of claim 8 including through the use of a software interface, displaying and managing a list of currently scheduled tests, displaying and managing a list of a plurality of test sites, and displaying and managing the list of the plurality of departments.

10. The method of claim 7 including through the use of a software interface, searching for and displaying candidates that both meet department minimum criteria and the candidate department preference, managing department information, and managing department minimum hiring criteria.

11. The method of claim 7 including through the use of a software interface, displaying and managing the times, dates, and locations for any scheduled tests, managing test site information, administering tests.

12. The method of claim 7 including through the use of a software interface, displaying candidate status, scheduled tests, and test scores, receiving personal candidate information, selecting one or more of the plurality of departments to have access to the candidate test scores, and making a test reservation.

13. A system for testing a plurality of candidates at a plurality of test sites and generating a qualified list of candidates for each of a plurality of departments, the system comprising:
a means for storing a list of the plurality of departments of the organization, a list of the plurality of test sites, and a list of the plurality of candidates;
a means for scheduling tests at the plurality of test sites and receiving the test results;
a means for receiving candidate information and for receiving a candidate department preference for each of the plurality of candidates;
a means for establishing department minimum hiring criteria for each of the plurality of departments; and
a means for a qualified list of candidates for each of the plurality of departments based on department minimum hiring criteria, the candidate department preference, and the test results.

14. The system of claim 13 including a means for adding or deleting test sites from the list of the plurality of test sites or for adding or deleting departments from the list of the plurality of departments.

15. The system of claim 13 including means for displaying and managing currently scheduled tests, means for displaying and managing the list of the plurality of test sites, and a means for displaying and managing the list of the plurality of departments.

16. The system of claim 13 including a means for searching for and displaying candidates that both meet department minimum criteria and the candidate department preference, a means for managing department information, and a means for managing department minimum criteria.

17. The system of claim 13 including a means for displaying the times, dates, and locations for any scheduled tests, a means for adding a new test, a means for managing test site information, and a means for administering a test.

18. The system of claim 13 including a means for displaying candidate status, scheduled tests, and test scores, a means for receiving personal candidate information, a means for selecting one or more of the plurality of departments to have access to the candidate test scores, and a means for making a test reservation.
